(19) United States
(12) Patent Application Publication
(10) Pub. No.: US 2025/0327316 A1
(43) Pub. Date: Oct. 23, 2025

(54) FRAME STRIP INSTALLATION STRUCTURE

(71) Applicant: Guangdong Rosery Bath Equipment Co.,Ltd., Zhongshan (CN)

(72) Inventors: Wei Xu, Zhongshan (CN); Songhua Cao, Zhongshan (CN); Zizhang Li, Zhongshan (CN); Sijia Xu, Shenzhen (CN)

(21) Appl. No.: 18/884,241

(22) Filed: Sep. 13, 2024

(30) Foreign Application Priority Data
Apr. 18, 2024 (CN) 202420815278.3

(51) Int. Cl. E04F 21/00

(52) U.S. Cl. CPC E04F 21/0038

(57) ABSTRACT

A frame strip installation structure is provided, which includes a frame strip, an installation seat, and a connector. The frame strip has a cavity with an opening at a side, the installation seat is configured to be adhesively installed on a wall. The connector is respectively connected to the installation seat and the frame strip. The opening of the cavity faces the wall, both the installation seat and the connector are accommodated in the cavity. The connector has an adjustable state and a locking state. When the connector is in the adjustable state, the frame strip moves relative to the installation seat so as to adjust an installation position relative to the wall. When the connector is in the locking state, the frame strip is fixed relative to the installation seat. When the frame strip is installed against the wall, there is no need to drill holes in the wall.

### CROSS-REFERENCE TO RELATED APPLICATIONS

This application claims priority to Chinese Patent Application No. 202420815278.3, filed on Apr. 18, 2024, which is hereby incorporated by reference in its entirety.

### TECHNICAL FIELD

The present disclosure relates to the field of sanitary and bathroom equipment technologies, and in particular, to a frame strip installation structure.

### BACKGROUND

The existing door frames for shower door are usually composed of multiple frame strips. For the frame strips on both sides that are close to the wall, they are usually installed and fixed to the wall by drilling holes with screws. This installation way may cause damage to the wall, especially when the drilling operation is incorrect, it is easy to damage the wall structure and affect an appearance of the wall. Besides, considering an existence of pipelines or lines in the wall, there is a possibility of damaging the pipelines or lines inside the wall during drilling, which can cause safety issues. Some of the frame strips are directly fixed to the wall by bonding, and the position of the frame strips is difficult to adjust. If there is a deviation in the bonding position, the frame strips are easily installed crooked or offset, which affects an overall installation of the shower door. Adjusting the position of the frame strips is more complicated.

### SUMMARY

The present disclosure aims to solve at least one of the technical problems existing in the prior art. Therefore, the present disclosure proposes a frame strip installation structure, which is installed on a wall by bonding an installation seat. The frame strip is connected to the installation seat through a connector, without a need to drill holes in the wall. The frame strip can move relative to the installation seat so as to adjust an installation position relative to the wall, it is convenient to install and use.

According to some embodiments of the present disclosure, a frame strip installation structure includes a frame strip, an installation seat, and a connector. The frame has a cavity with an opening at a side, the installation seat is configured to be adhesively installed on a wall. The connector is respectively connected to the installation seat and the frame strip. The opening of the cavity is faced the wall, both the installation seat and the connector are accommodated in the cavity. The connector has an adjustable state and a locking state. When the connector is in the adjustable state, the frame is moved relative to the installation seat so as to adjust an installation position relative to the wall. When the connector is in the locking state, the frame strip is fixed relative to the installation seat.

According to some embodiments of the present disclosure, the frame strip installation structure has at least the following beneficial effects: during installation, the installation seat is first bonded and installed on the wall, and then the frame strip and the installation seat are connected through the connector. When it is necessary to adjust an installation position of the frame strip, the connector is the adjustable state. At this time, the frame strip can move relative to the installation seat so as to adjust the installation position relative to the wall. After the adjustment is completed, the connector is in the locking state, the frame strip is fixed relative to the installation seat, and a locking after adjusting the installation position is achieved. Through the above structure, when installing the frame strip against the wall, there is no need to drill holes in the wall to avoid damaging it, and the installation position of the frame strip can be adjusted adaptively, which is conducive to avoiding an installation deviation of the frame strip due to a deviation of an adhesive position of the installation seat, and is convenient for installation and use.

According to some embodiments of the present disclosure, the connector includes a first threaded piece, the cavity is provided with a first connection block therein, the installation seat is provided with a first threaded hole; the first threaded piece penetrates the first connection block and is threaded with the first threaded hole, the first threaded piece abuts against the first connection block and renders the first connection block have a tendency to move towards the installation seat; the frame strip is provided with a first avoidance hole corresponding to the first threaded piece.

According to some embodiments of the present disclosure, the first connection block is provided with a first adjustment hole, the first threaded piece penetrates the first connection block through the first adjustment hole, and the first threaded piece is moved left and right relative to the first adjustment hole.

According to some embodiments of the present disclosure, the connector further includes a second threaded piece, the first connection block is provided with a second threaded hole, the second threaded piece is threaded with the second threaded hole, the frame strip is provided with a second avoidance hole corresponding to the second threaded piece, the second threaded piece abuts against the installation seat or the wall and renders the first connection block have a tendency to move away from the installation seat.

According to some embodiments of the present disclosure, the connector includes a third threaded piece and a second connection block, the installation seat is provided with a third threaded hole; the third threaded piece penetrates the second connection block and is threaded with the third threaded hole, the third threaded piece is rotated to render left and right sides of the second connection block to be abutted against or to be not abutted against the frame strip, and the frame strip is provided with a third avoidance hole corresponding to the third threaded piece.

According to some embodiments of the present disclosure, the cavity is provided with a third connection block, and there are two third connection blocks provided on the left and right sides of the second connection block, respectively; the left and right sides of the second connection block and a side of the third connection block facing the second connection block are both provided with a tooth-surface structure, the second connection block and the third connection block are mutually matched with each other through the tooth-surface structure.

According to some embodiments of the present disclosure, the connector further includes a fourth connection block, the second connection block is provided with a connection hole, the fourth connection block is provided in the connection hole; the third threaded piece penetrates the fourth connection block and is threaded with the third threaded hole; the third threaded piece drives the fourth connection block to move forward and backward by rotation; a peripheral side of the fourth connection block is provided with a conical surface or an inclined surface that presses the left and right sides of the second connection block so that the left and right sides of the second connection block abut against with the frame strip.

According to some embodiments of the present disclosure, the second connection block is capable of moving left and right relative to the third threaded piece.

According to some embodiments of the present disclosure, the second connection block is provided with a magnetic attraction part, which is magnetically cooperated with the installation seat.

According to some embodiments of the present disclosure, the frame strip installation structure further includes a sealant, which is provided between the frame strip and the wall.

The additional aspects and advantages of the present disclosure will be partially presented in the following description, some of which will become apparent from the following description, or learned through practice of the present disclosure.

### BRIEF DESCRIPTION OF DRAWINGS

The above and/or additional aspects and advantages of the present disclosure will become apparent and easy to understand from the description of the embodiments in combination with the following drawings.

FIG. 1 is a schematic diagram of a first embodiment of a frame strip installation structure of the present disclosure.

FIG. 2 is an exploded schematic diagram of the frame strip installation structure in

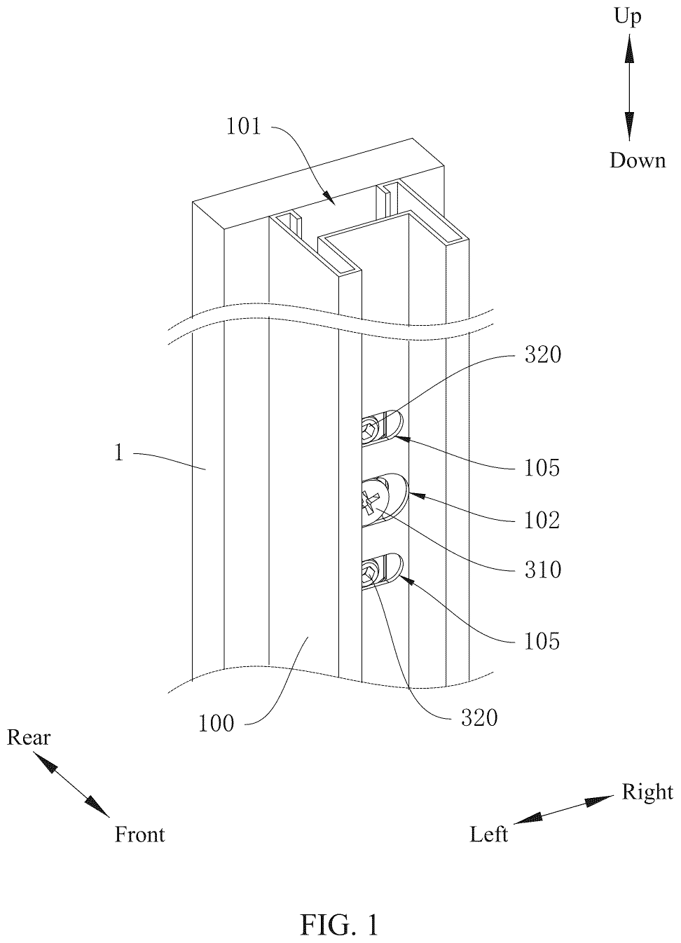

FIG. 1.

FIG. 3 is a first sectional structural diagram of the frame strip installation structure in FIG. 1.

FIG. 4 is a second sectional structural diagram of the frame strip installation structure in FIG. 1.

FIG. 5 is a schematic diagram of a second embodiment of the frame strip installation structure of the present disclosure.

FIG. 6 is an exploded schematic diagram of the frame strip installation structure of in FIG. 5.

FIG. 7 is a first sectional structural diagram of the frame strip installation structure in FIG. 5.

FIG. 8 is a second sectional structural diagram of the frame strip installation structure in FIG. 5.

Numeral reference: frame strip 100, cavity 101, first avoidance hole 102, first adjustment hole 103, second threaded hole 104, second avoidance hole 105, third avoidance hole 106, first connection block 110, third connection block 120, installation seat 200, first threaded hole 201, third threaded hole 202, connector 300, tooth-surface structure 301, connection hole 302, second adjustment hole 303, first threaded piece 310, second threaded piece 320, third threaded piece 330, second connection block 340, magnetic attraction part 341, fourth connection block 350, wall 1.

### DESCRIPTION OF EMBODIMENTS

Embodiments of the present disclosure are described in detail below, and examples of the embodiments are shown in the accompanying drawings, where the same or similar reference numerals from beginning to end represent the same or similar elements or members with the same or similar functions. The embodiments described below with reference to the accompanying drawings are exemplary and are only used to explain the present disclosure, and should not be understood as limiting the present disclosure.

In the description of the present disclosure, it should be understood that if it involves an orientation description, such as up, down, front, back, left, right, etc., an orientation or position relationship indicated is based on the orientation or position relationship shown in the accompanying drawings, it is only for a convenience of describing the present disclosure and simplifying the description, and does not indicate or imply that the device or component referred to must have a specific orientation, be constructed and operated in a specific orientation, and therefore cannot be understood as a limitation of the present disclosure.

In the description of the present disclosure, if there are several words such as “greater than”, “less than”, “more than”, “below”, “within”, etc., where “several” means one or more, “multiple” means two or more, “greater than”, “less than”, “exceeding”, etc. are understood as not including this number, and “above”, “below”, “within”, etc. are understood as including this number.

If there is a description that “first” and “second” are only used to distinguish technical features, and cannot be understood as indicating or implying a relative importance or implying the quantity or order of the indicated technical features.

In the description of the present disclosure, unless otherwise explicitly limited, terms such as “setting”, “installation”, and “connection” should be understood broadly. Technical personnel in the relevant technical field can reasonably determine specific meanings of the above terms in the present disclosure based on the specific content of the technical solution.

Referring to FIGS. 1 to 8, a frame strip installation structure includes a frame strip 100, an installation seat 200, and a connector 300. The frame strip 100 has a cavity 101 with an opening at a side, and the installation seat 200 is configured to be adhesively installed on a wall 1. The connector 300 is connected to the installation seat 200 and the frame strip 100 respectively. The opening of the cavity 101 is faced to the wall 1, and both the installation seat 200 and the connector 300 can be accommodated in the cavity 101. The connector 300 has an adjustable state and a locking state. When the connector 300 is in the adjustable state, the frame strip 100 can move relative to the installation seat 200 so as to adjust an installation position relative to the wall 1. When the connector 300 is in the locking state, the frame strip 100 is fixed relative to the installation seat 200.

It can be understood that, as shown in FIGS. 1, 2, 5, and 6, the frame strip 100 is a profile structure extending in an up-down direction, and its cross-section is roughly in a “concave” shape. The wall 1 is located behind the frame strip 100, and the opening of the cavity 101 is faced the back. When installing, the installation seat 200 is first adhesive and installed on the wall 1, and then the frame strip 100 and the installation seat 200 are connected by the connector 300. The installation seat 200 and the connector 300 are both stored in the cavity 101, which is conducive to improving an aesthetic appearance. When it is necessary to adjust the installation position of the frame strip 100, the connector 300 can be in the adjustable state. At this time, the frame strip 100 can move relative to the installation seat 200 so as to adjust the installation position relative to the wall 1. After the adjustment is completed, the connector 300 is in the locking state, and the frame strip 100 is fixed relative to the installation seat 200, thereby achieving a locking of the installation position after adjustment. Through the above structure, when installing the frame strip 100 against the wall, there is no need to drill holes in the wall 1, thereby avoiding damage to the wall 1. The installation position of the frame strip 100 can be adjusted adaptively, which is conducive to avoiding an installation deviation of the frame strip 100 caused by an adhesive position deviation of the installation seat 200, and it is convenient for installation and use.

In a practical application, specific structures of the frame strip 100, installation seat 200, and connector 300 can be set according to an actual usage need, and will not be described in detail here. Specific explanations will be provided below.

In some embodiments, the connector 300 includes a first threaded piece 310, the cavity 101 is provided with a first connection block 110, and the installation seat 200 is provided with a first threaded hole 20. The first threaded piece 310 penetrates the first connection block 110 and is threaded with the first threaded hole 201. The first threaded piece 310 can abut against the first connection block 110 and render the first connection block 110 have a tendency to move towards the installation seat 200. The frame strip 100 is provided with a first avoidance hole 102 corresponding to the first threaded piece 310.

It can be understood that, as shown in FIGS. 1 to 4, a first embodiment of the present disclosure is illustrated. The first threaded piece 310 is a bolt, and the first connection block 110 is fixed to the frame strip 100. The first threaded piece 310 penetrates the first connection block 110 and is threaded with the first threaded hole 201. The first avoidance hole 102 is directly facing a front side of the first threaded piece 310. During installation, an installation tool can operate the first threaded piece 310 to rotate through the first avoidance hole 102 and adjust a tightness fit; the first threaded piece 310 is tightened, a head of the bolt structure is used to abut against the first connection block 110, a tension is generated and acted on the first connection block 110, and the first connection block 110 is caused to have a tendency to move backwards. The first connection block 110 is pressed tightly to achieve a connection between the frame strip 100 and the installation seat 200. Its structure is simple and easy to use.

In a practical application, the first connection block 110 can be embedded in the frame strip 100, or fixed to the frame strip 100 by bonding, or the first connection block 110 and the frame strip 100 can be an integrated structure, which can be set according to an actual usage need.

In an implementation, the first connection block 110 is provided with a first adjustment hole 103, and the first threaded piece 310 penetrates the first connection block 110 through the first adjustment hole 103. The first threaded piece 310 can move left and right relative to the first adjustment hole 103.

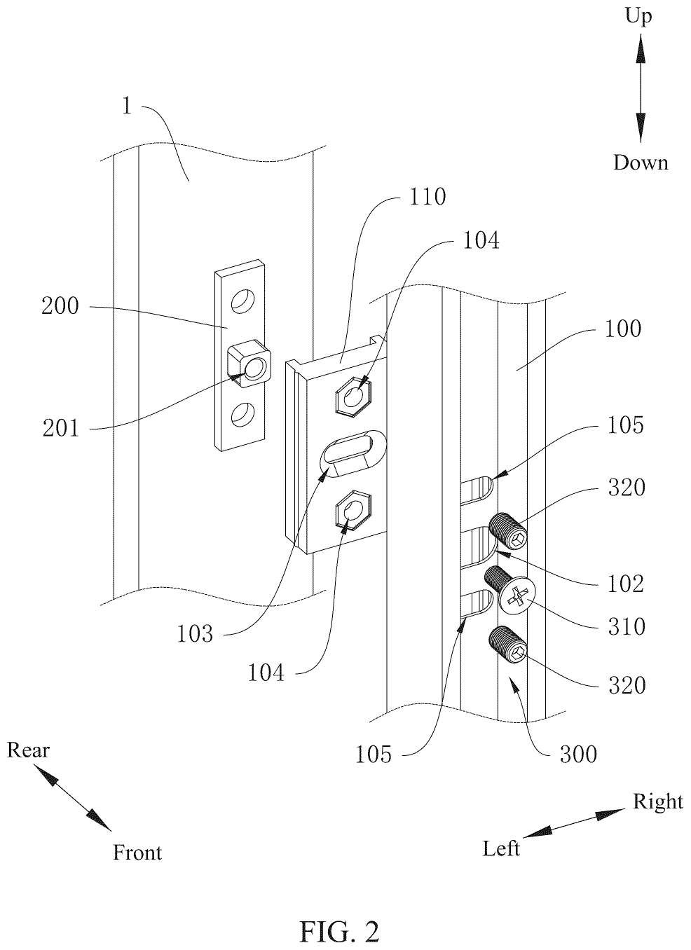

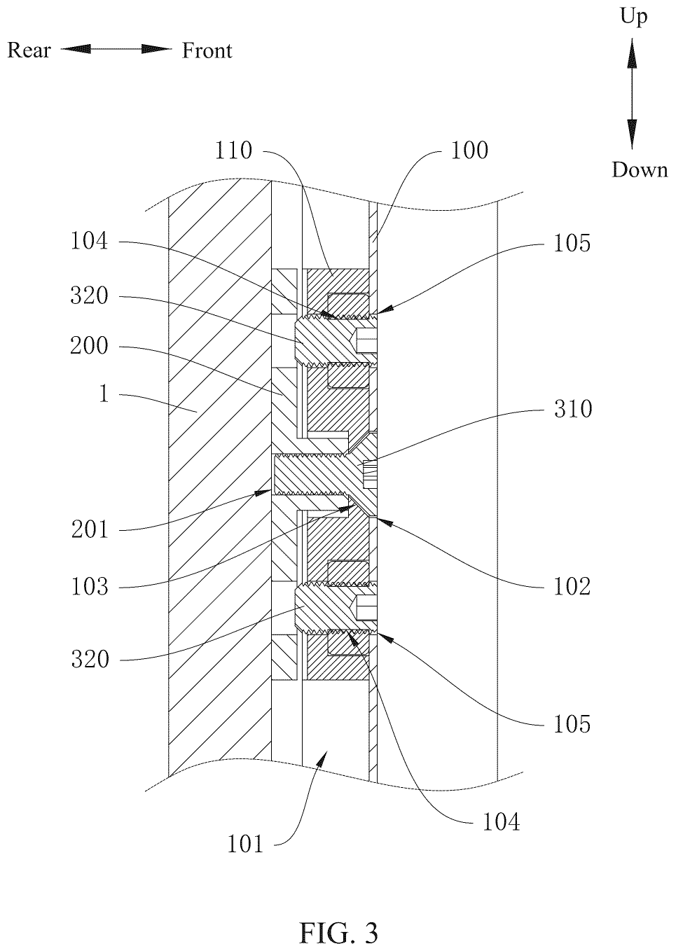

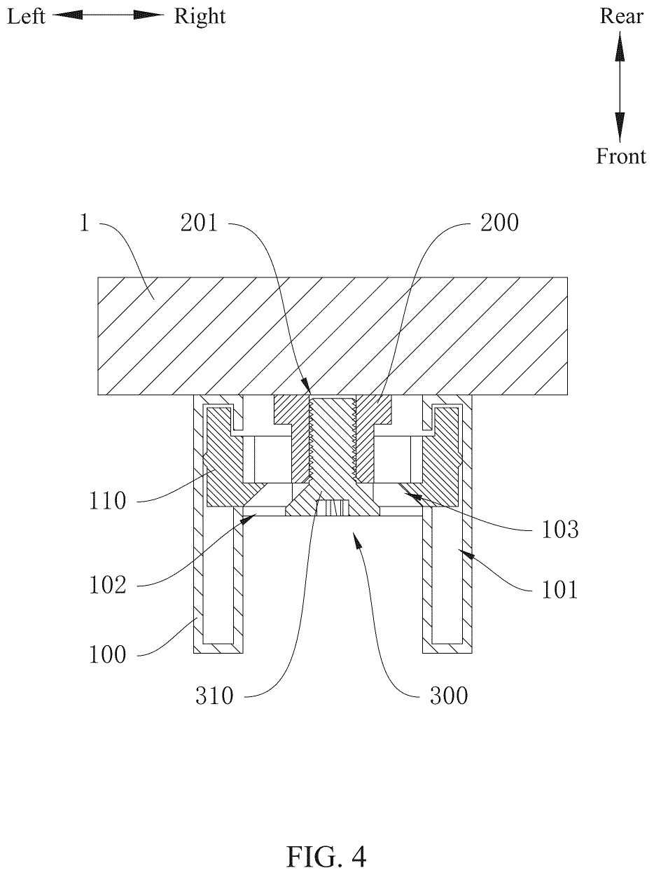

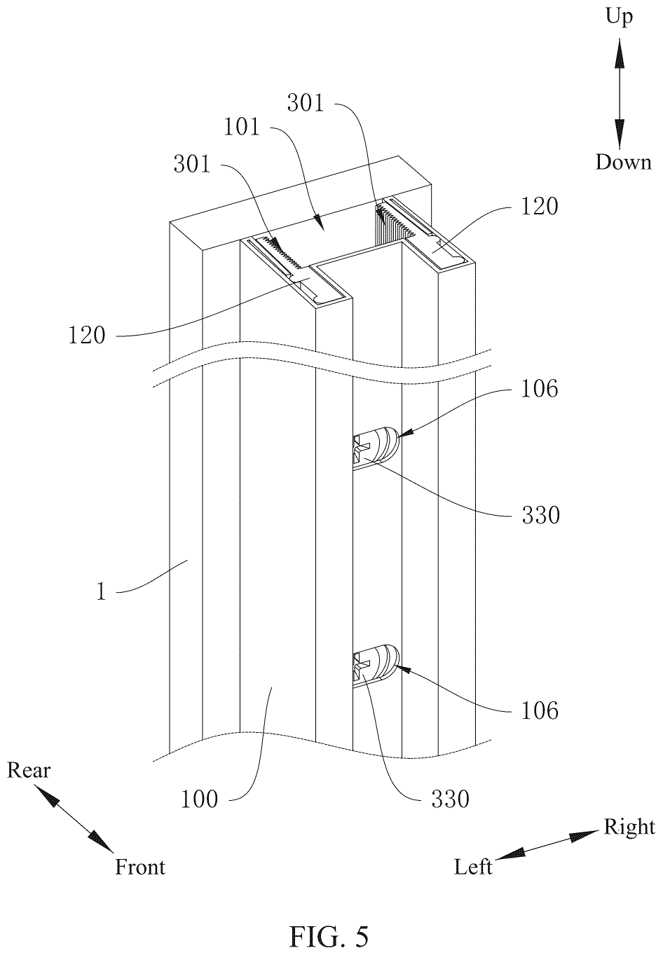

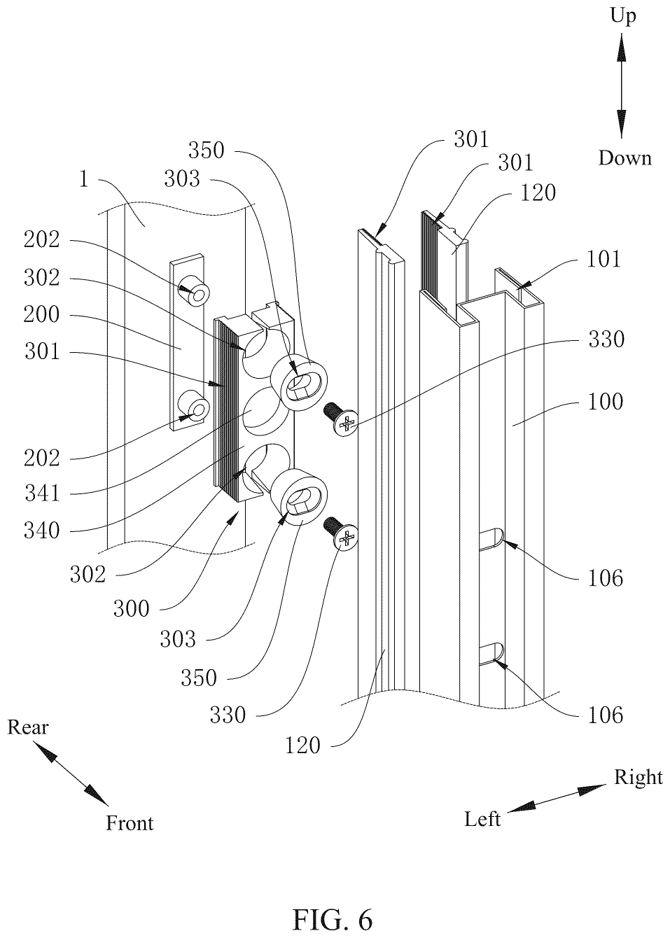

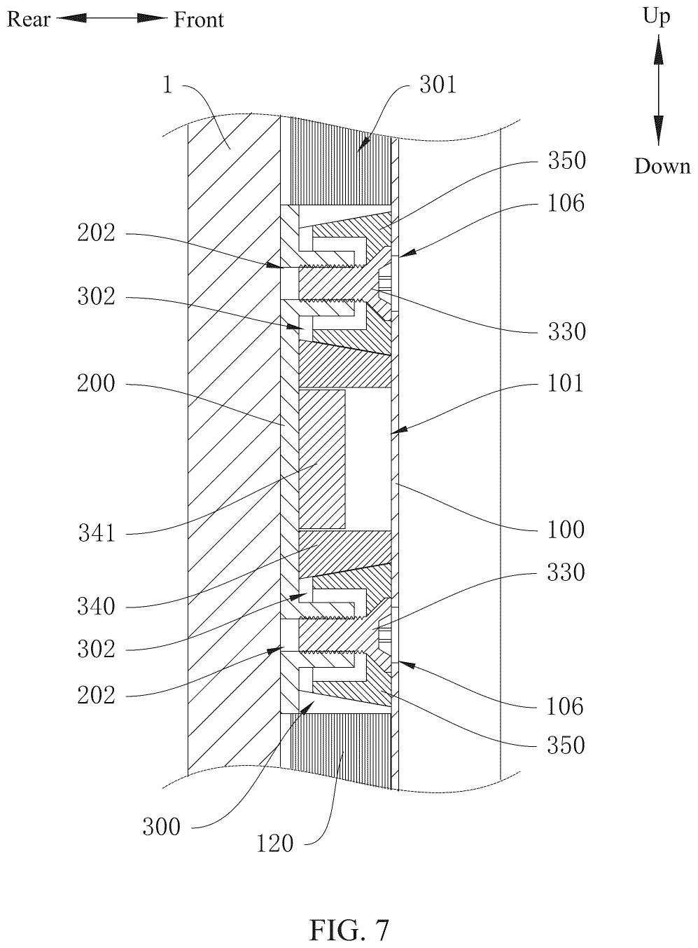

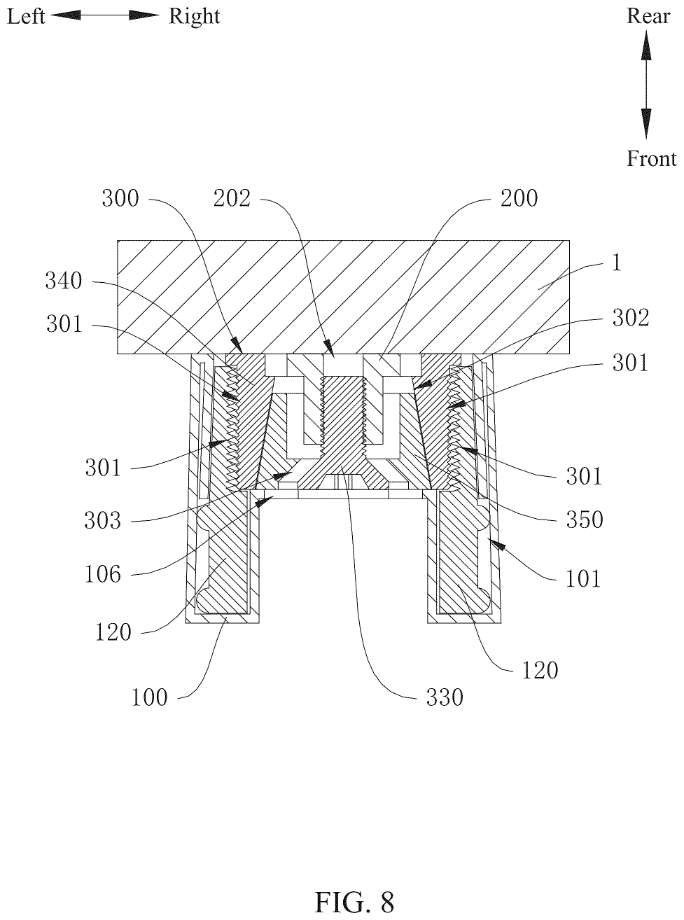

It can be understood that, as shown in FIGS. 2, 3, and 4, the first adjustment hole 103 has a waist shaped hole structure that extends in a left-and-right direction. The first threaded piece 310 penetrates the first connection block 110 through the first adjustment hole 103. When in use, the first threaded piece 310 can be loosened to place the connector 300 in the adjustable state. At this time, the frame strip 100 and the first connection block 110 can be operated to move left and right together. The first threaded piece 310 can move left and right relative to the first adjustment hole 103 so as to adapt to the position adjustment of the frame strip 100. After the adjustment is completed, the first threaded piece 310 can be tightened to lock the connector 300 in place, thereby achieving the position locking after adjustment for ease of use.

In a practical application, besides the above structure, the connector 300 further include a slide rail and a slider. The slider is connected to the frame strip 100 through a threaded piece and cooperates with the slide rail. A cooperation between the two can be used to allow the frame strip 100 to move relative to the installation seat 200, thereby achieving the position adjustment. After adjustment is completed, the threaded piece can be tightened to press the slider tightly against the slide rail, thereby achieving the position locking. Specific changes can be made according to an actual usage need.

In an implementation mode, the connector 300 further includes a second threaded piece 320. The first connection block 110 is provided with a second threaded hole 104, and the second threaded piece 320 is threaded with the second threaded hole 104. The frame strip 100 is provided with a second avoidance hole 105 corresponding to the second threaded piece 320. The second threaded piece 320 can abuts against the installation seat 200 or the wall 1 and render the first connection block 110 have a tendency to move away from the installation seat 200.

It can be understood that, as shown in FIGS. 1, 2, and 3, there are two second threaded pieces 320 provided above and below the first threaded piece 310. The first connection block 110 is correspondingly provided with two second threaded holes 104, and the two second threaded pieces 320 are respectively threaded with the two second threaded holes 104. There are two second avoidance holes 105 provided corresponding to the two second threaded pieces 320. During installation, the installation tool can operate the second threaded pieces 320 to rotate through the second avoidance hole 105, so that a rear end of the second threaded piece 320 abuts against the installation seat 200 or the wall 1, thereby a thrust force is generated and acted on the first connection block 110, the first connection block 110 is caused to have a tendency to move away from the installation seat 200, combined with the first threaded piece 310, the first connection block 110 have a tendency to move towards the installation seat 200. By using the pull and push of the first threaded piece 310 and the second threaded piece 320, front and rear positions of the first connection block 110 and the frame strip 100 are fixed.

When it is necessary to adjust the front and rear positions of the frame strip 100 relative to the wall 1, the first threaded piece 310 and/or the second threaded piece 320 can be loosened to move the frame strip 100 forward or backward. After adjusting the position, the second threaded piece 320 and/or the first threaded piece 310 can be twisted to render the second threaded piece 320 to abut against the installation seat 200 or the wall 1, and so as to tighten the first connection block 110. The first threaded piece 310 abuts against the first connection block 110, the first connection block 110 is tightened so as to achieve the fixed position of the frame strip 100 after adjustment. By combining left and right movement adjustments mentioned above, the position adjustment of the frame strip 100 in two directions can be achieved, thereby improving the adaptability.

In a practical application, the second threaded hole 104 can be directly drilled and processed on the first connection block 110, or the second threaded hole 104 can be formed by embedding a nut on the first connection block 110. Specific settings can be made according to an actual usage need.

In some embodiments, the connector 300 includes a third threaded piece 330 and a second connection block 340. The installation seat 200 is provided with a third threaded hole 202, and the third threaded piece 330 penetrates the second connection block 340 and is threaded with the third threaded hole 202. The third threaded piece 330 can rotate to render the left and right sides of the second connection block 340 to be abutted against or to be not abutted against the frame strip 100. The frame strip 100 is provided with a third avoidance hole 106 corresponding to the third threaded piece 330.

It can be understood that, as shown in FIGS. 5 to 8, a second embodiment of the present disclosure is illustrated, the third threaded piece 330 is a bolt. The third threaded piece 330 penetrates the second connection block 340 and is threaded with the third threaded hole 202 on the installation seat 200. The third avoidance hole 106 is provided directly at a front end of the third threaded piece 330. During installation, the installation tool can operate the third threaded piece 330 to rotate through the third avoidance hole 106. The third threaded piece 330 can deform the left and right sides of the second connection block 340 by rotation and be fixed by abutting against the frame strip 100, thereby achieving the connection between the frame strip 100 and the installation seat 200. When it is necessary to adjust front and rear installation positions of the frame strip 100, the third threaded piece 330 can be loosened, and the connector 300 is in the adjustable state, so that the left and right sides of the second connection block 340 are separated from the frame strip 100, and the contact is released, so that the frame strip 100 can move forward and backward relative to the wall 1. After adjusting the position, the third threaded piece 330 is tighten, and the connector 300 is in the locking state. The left and right sides of the second connection block 340 are deformed and are fixed by abutting against the frame strip 100, thereby achieving the position locking. Its structure is simple, and it is easy to install and adjust.

In a practical application, besides to being fixed by abutting against the frame strip 100 through the deformation the left and right sides of the second connection block 340, the left and right sides of the second connection block 340 can also be set to move left and right. When tightening the third threaded piece 330, the left and right sides can be driven to move left and right respectively so as to be fixed by abutting against the frame strip 100. Loosening the third threaded piece 330 can reset its left and right sides. A linkage manner between the forward and backward movements of the third threaded piece 330 and a corresponding side movement of the second connection block 340 can be achieved through a connecting rod structure or a wedge-shaped structure, which can be changed according to an actual usage need.

In an implementation mode, the cavity 101 is provided with a third connection block 120, and there are two third connection blocks 120 provided on the left and right sides of the second connection block 340. The left and right sides of the second connection block 340 and a side of the third connection block 120 facing the second connection block 340 are both provided with a tooth-surface structure 301. The second connection block 340 and the third connection block 120 are abutted against and cooperate with each other through the tooth-surface structure 301.

It can be understood that, as shown in FIGS. 5, 6, 7, and 8, the two third connection blocks 120 are located on the left and right sides of the second connection block 340, respectively. The left and right sides of the second connection block 340 and the side of the third connection block 120 facing the second connection block 340 are both provided with the tooth-surface structure 301. When in use, the second connection block 340 and the third connection block 120 can abut against and cooperate with each other through the tooth-surface structure 301, and the tooth surfaces mesh with each other, thereby achieving a relatively stable position locking effect. In a practical application, the third connection block 120 can be embedded in the frame strip 100, or fixed to the frame strip 100 by bonding, or the third connection block 120 can be an integrated structure with the frame strip 100; besides to providing with the tooth-surface structure 301, the contact between the second connection block 340 and the third connection block 120 can also be directly locked by frictional force, which can be set according to an actual usage need.

In an implementation mode, the connector 300 further includes a fourth connection block 350, the second connection block 340 is provided with a connection hole 302, the fourth connection block 350 is provided in the connection hole 302, and the third threaded piece 330 penetrates the fourth connection block 350 and is threaded with the third threaded hole 202. The third threaded piece 330 can drive the fourth connection block 350 to move forward and backward by rotation. A peripheral side of the fourth connection block 350 is provided with a conical surface or an inclined surface that presses the left and right sides of the second connection block 340, so that the left and right sides of the second connection block 340 abut against the frame strip 100.

It can be understood that, as shown in FIGS. 6, 7, and 8, the peripheral side of the fourth connection block 350 is a conical structure, and a hole wall of the connection hole 302 is correspondingly conical. The fourth connection block 350 is provided in the connection hole 302, and the third threaded piece 330 penetrates the fourth connection block 350 and is threaded with the third threaded hole 202. The third threaded piece 330 is twisted to move the third threaded piece 330 backwards relative to the installation seat 200, the fourth connection block 350 is driven to move backwards. The fourth connection block 350 compresses the left and right sides of the second connection block 340 through the conical surface on the peripheral side, the left and right sides of the second connection block 340 is caused to abut against the third connection block 120 of the frame strip 100. The structure is simple and easy to use.

In a practical application, besides to the conical structure, the left and right sides of the fourth connection block 350 can also be designed as an inclined structure, so that when the fourth connection block 350 moves backward, it can compress the left and right sides of the second connection block 340 to deform, or the inclined surface is used to form a wedge-shaped structure so as to push the left and right sides of the second connection block 340 to move. Specific settings can be made according to an actual usage need.

In an implementation, the second connection block 340 can move left and right relative to the third threaded piece 330. It can be understood that, as shown in FIGS. 6 and 8, the fourth connection block 350 is provided with a second adjustment hole 303, which has a waist shaped hole structure extending in the left-and-right direction. The third threaded piece 330 penetrates the fourth connection block 350 through the second adjustment hole 303. When it is necessary to adjust the installation position of the frame strip 100 left and right, the third threaded piece 330 can be loosened to place the connector 300 in the adjustable state. At this time, the frame strip 100 and the third connection block 120 can be operated to move left and right, the second connection block 340 and the fourth connection block 350 in the cavity 101 are driven to move left and right together. The third threaded piece 330 can move left and right relative to the second adjustment hole 303 so as to adapt to the position adjustment of the frame strip 100. After the adjustment is completed, the third threaded piece 330 can be tightened to lock the connector 300 in the locking state, thereby achieving the position locking after adjustment, and it is convenience to use.

In an implementation mode, the second connection block 340 is provided with a magnetic attraction part 341, which can magnetically cooperate with the installation seat 200. It can be understood that, as shown in FIGS. 6 and 7, by providing with the magnetic attraction part 341, the magnetic attraction part 341 can be used to magnetically cooperate with the installation seat 200. When adjusting the position, it can ensure that the second connection block 340 can be stably attached to the installation seat 200, rendering it easy to use. In a practical application, the magnetic attraction part 341 can be made of magnetic material, and the installation seat 200 can be made of corresponding metal material or magnetic material that attracts magnetic materials. In an implementation mode, the magnetic attraction part 341 can be made of metal material, and the installation seat 200 can be made of magnetic material. Specific settings can be adjusted according to an actual use need.

In some embodiments, the frame strip installation structure further includes a sealant (not shown in the drawing), which is provided between the frame strip 100 and the wall 1. It can be understood that during installation, the installation seat 200 is first bonded and installed on the wall 1, and then the frame strip 100 and the installation seat 200 are connected through the connector 300, so that the connector 300 is in the adjustable state. At this time, the frame strip 100 can be operated to move and adjust its installation position relative to the wall 1. After the adjustment is completed, the connector 300 is in the locking state, and the frame strip 100 is fixed relative to the installation seat 200, thereby achieving the locking after the installation position adjustment. Then, the sealant is filled between the frame strip 100 and the wall 1. On the one hand, the sealant is used to seal a gap between the frame strip 100 and the wall 1, thereby improving a sealing performance. On the other hand, the sealant can be used to increase an adhesion between the frame strip 100 and the wall 1, rendering an adhesive bonding between the frame strip 100 and the wall 1 to be stable and improving an installation stability of the frame strip 100. In a practical application, specific settings of the sealant can be set according to an actual need of use.

The detailed description of the embodiments of the present disclosure has been provided above in combination with the accompanying drawings. However, the present disclosure is not limited to the above embodiments, and various changes can be made within the knowledge scope of those skilled in the art without departing from the purpose of the present disclosure.

What is claimed is:

1. A frame strip installation structure, comprising:
a frame strip, a side of the frame strip is provided with a cavity with an opening;
an installation seat, configured to be adhesively installed on a wall;
a connector, which is respectively connected the installation seat and the frame strip;
wherein the opening of the cavity is faced to the wall, both the installation seat and the connector are accommodated in the cavity;
wherein the connector has an adjustable state and a locking state; when the connector is in the adjustable state, the frame strip is moved relative to the installation seat so as to adjust an installation position relative to the wall, and when the connector is in the locking state, the frame strip is fixed relative to the installation seat.

2. The frame strip installation structure according to claim 1, wherein the connector comprises a first threaded piece, the cavity is provided with a first connection block therein, the installation seat is provided with a first threaded hole; the first threaded piece penetrates the first connection block and is threaded with the first threaded hole,
the first threaded piece abuts against the first connection block and renders the first connection block have a tendency to move towards the installation seat;
the frame strip is provided with a first avoidance hole corresponding to the first threaded piece.

3. The frame strip installation structure according to claim 2, wherein the first connection block is provided with a first adjustment hole, and the first threaded piece penetrates the first connection block through the first adjustment hole, and the first threaded piece is moved left and right relative to the first adjustment hole.

4. The frame strip installation structure according to claim 2, wherein the connector further comprises a second threaded piece, the first connection block is provided with a second threaded hole, the second threaded piece is threaded with the second threaded hole,
the frame strip is provided with a second avoidance hole corresponding to the second threaded piece, the second threaded piece abuts against the installation seat or the wall and renders the first connection block have a tendency to move away from the installation seat.

5. The frame strip installation structure according to claim 1, wherein the connector comprises a third threaded piece and a second connection block, the installation seat is provided with a third threaded hole;
the third threaded piece penetrates the second connection block and is threaded with the third threaded hole, the third threaded piece is rotated to render left and right sides of the second connection block to be abutted against or to be not abutted against the frame strip, and the frame strip is provided with a third avoidance hole corresponding to the third threaded piece.

6. The frame strip installation structure according to claim 5, wherein the cavity is provided with a third connection block, and there are two third connection blocks provided on the left and right sides of the second connection block, respectively;
the left and right sides of the second connection block and a side of the third connection block facing the second connection block are both provided with a tooth-surface structure,
the second connection block and the third connection block are mutually matched through the tooth-surface structure.

7. The frame strip installation structure according to claim 5, wherein the connector further comprises a fourth connection block, the second connection block is provided with a connection hole, the fourth connection block is provided in the connection hole;
the third threaded piece penetrates the fourth connection block and is threaded with the third threaded hole;
the third threaded piece drives the fourth connection block to move forward and backward by rotation;
a peripheral side of the fourth connection block is provided with a conical surface or an inclined surface that presses the left and right sides of the second connection block so that the left and right sides of the second connection block abut against with the frame strip.

8. The frame strip installation structure according to claim 5, wherein the second connection block is capable of moving left and right relative to the third threaded piece.

9. The frame strip installation structure according to claim 5, wherein the second connection block is provided with a magnetic attraction part, which is magnetically cooperated with the installation seat.

10. The frame strip installation structure according to claim 1, further comprises a sealant, which is provided between the frame strip and the wall.
